(19) United States
(12) Patent Application Publication
(10) Pub. No.: US 2017/0157605 A1
(43) Pub. Date: Jun. 8, 2017

(54) METHODS AND COMPOSITIONS FOR LOW VOLUME LIQUID HANDLING

(71) Applicants: Justin Lock, San Francisco, CA (US); Hoai Nguyen, San Jose, CA (US); Daniel DeSloover, Millbrae, CA (US)

(72) Inventors: Justin Lock, San Francisco, CA (US); Hoai Nguyen, San Jose, CA (US); Daniel DeSloover, Millbrae, CA (US)

(21) Appl. No.: 15/369,410

(22) Filed: Dec. 5, 2016

Related U.S. Application Data
(60) Provisional application No. 62/263,543, filed on Dec. 4, 2015.

(51) Int. Cl. B01L 3/00

(52) U.S. Cl. CPC B01L 3/50857; B01L 3/527; B01L 2200/0673; B01L 2200/06; B01L 2200/16

(57) ABSTRACT

Systems, methods, and compositions are provided for low volume liquid handling.

### CROSS-REFERENCE TO RELATED APPLICATION

The present application is a nonprovisional of and claims priority to U.S. Provisional Application No. 62/263,543, filed Dec. 4, 2015, the entire disclosure of which is incorporated by reference herein in its entirety for all purposes.

### BACKGROUND OF THE INVENTION

Method and devices for low volume liquid handling are useful in the biotechnological, chemical, and materials science arts. In the biotechnological arts, low volume methods can accommodate new analytical techniques, particularly where samples are available in limiting quantity. A variety of approaches are known for manipulating low volume samples, including capillary-based methods and microfluidic methods (e.g., using droplets, nanowells, or channels).

One challenge related to handling small liquid volumes is the possibility of substantial evaporation. Evaporation generally has been addressed by using an overlay of silicone oil or wax. See, e.g., WO 2012/024,103. Qiagen markets a hydrophobic, low-viscosity PCR encapsulation barrier (VAPOR-LOCK®) for use in relatively high volume PCR reactions. WO 1998/033,052 describes the use of a volatile cover liquid used to prevent evaporation from an underlying solution, where the volatility of the cover liquid is said to simplify the separation of the reaction solution from the cover liquid.

Another issue relates to the difficulty of stably regulating temperature of small liquid volumes. The lack of thermal inertia of the small liquid volume can amplify the effect of inadvertent or unavoidable thermal perturbations. For example, inadvertent evaporation of a small liquid volume can greatly affect temperature control. As another example, loading or transferring a small liquid volume to a container or using transfer devices that are not in thermal equilibrium with the low volume liquid can cause a transient and undesired changes in temperature.

Yet another issue relates to loss of sample during transfer of small volumes, especially when pipette tips are used for transfer. Specially designed pipette tips have been developed to minimize dead volume (e.g., Mosquito® HV liquid handling instrument; TTP Labtech, Melbourn, Herts, U.K.). However, these approaches require specialized equipment, are unsuitable for certain multistep reaction processes, and/or result in unacceptable loss of sample.

Thus, there remains a need for systems compositions and methods that can provide micro-scale liquid handling with macro-scale instrumentation and consumables. The present invention addresses these and other needs.

### BRIEF SUMMARY OF THE INVENTION

In one aspect, the present invention provides a method for low volume liquid handling of an aqueous reaction mixture, the method comprising combining a volume of the aqueous reaction mixture and a volume of a first immiscible liquid and a volume of a second immiscible liquid to produce a composition comprising the aqueous reaction mixture and the first and second immiscible liquids, wherein: the volume of the aqueous reaction mixture is at least 0.1 μL and not more than 7 μL; the volume of the first immiscible liquid is at least three times the volume of the aqueous reaction mixture; the volume of the second immiscible liquid is at least three times the volume of the aqueous reaction mixture; and one of the first immiscible liquid and the second immiscible liquid is less dense than the aqueous reaction mixture and the other immiscible liquid is more dense than the aqueous reaction mixture.

In some embodiments, the volume of the aqueous reaction mixture is at least 0.5 μL and not more than 5 μL. In some embodiments, the volume of the first immiscible liquid is at least twice the volume of the second immiscible liquid. In some embodiments, the composition has a total volume that is at least about 15 μL and not more than about 50 μL. In some embodiments, the combining comprises introducing the aqueous reaction mixture, first immiscible liquid, and second immiscible liquid into a tube or well. In some embodiments, the tube comprises a microcentrifuge tube having a volumetric capacity of about 0.2 mL. In some embodiments, the well comprises a well of a microplate having a volumetric capacity of about 0.36 mL. In some embodiments, the first immiscible liquid is less dense than the aqueous reaction mixture.

In some embodiments, the first immiscible liquid has a boiling point above 100° C. In some embodiments, the first immiscible liquid is more dense than the aqueous reaction mixture. In some embodiments, the first immiscible liquid comprises a linear or branched alkyl polymer. In some embodiments, the second immiscible liquid has a boiling point above 100° C. In some embodiments, the second immiscible liquid comprises a fluorocarbon polymer. In some embodiments, the second immiscible liquid is perfluorooctane. In some embodiments, the volume of the aqueous reaction mixture is about 2 μL, the volume of the first immiscible liquid is about 25 μL, and the volume of the second immiscible liquid is about 10 μL, wherein the first immiscible liquid is less dense than the aqueous reaction mixture and the second immiscible liquid is more dense than the aqueous reaction mixture.

In some embodiments, the aqueous reaction mixture comprises nucleic acid. In some embodiments, the aqueous reaction mixture comprises deoxyribonucleic acid (DNA). In some embodiments, the aqueous reaction mixture comprises ribonucleic acid (RNA). In some embodiments, the aqueous reaction mixture comprises DNA and RNA, wherein the DNA comprises adaptor ligated nucleic acid fragments, blocking oligonucleotides, and blocking DNA, and the RNA comprises labeled bait oligonucleotides, wherein the labeled bait oligonucleotides comprise sequences complementary to target fragments of the adaptor ligated nucleic acid fragments. In some embodiments, the composition comprising the aqueous reaction mixture comprising the DNA and RNA and the first and second immiscible liquids is formed by combining a first composition comprising an RNA aqueous reaction mixture and first and second immiscible liquids and a second composition comprising a DNA aqueous reaction mixture and first and second immiscible liquids.

In some embodiments, the aqueous reaction mixture comprises DNA, wherein the DNA comprises adaptor ligated nucleic acid fragments, blocking oligonucleotides, blocking DNA, and labeled bait oligonucleotides, wherein the labeled bait oligonucleotides comprise sequences complementary to target fragments of the adaptor ligated nucleic acid fragments. In some embodiments, the method further comprises combining the aqueous reaction mixture with a plurality of beads, wherein the beads are functionalized with an affinity reagent having affinity to the label of the labeled bait oligonucleotides. In some embodiments, the aqueous reaction mixture further comprises a plurality of beads, wherein the beads are functionalized with an affinity reagent having affinity to the label of the labeled bait oligonucleotides. In some embodiments, the labeled bait oligonucleotides comprise a biotin label and the affinity reagent comprises avidin or streptavidin.

In some embodiments, the aqueous reaction mixture is at a temperature of between about 37° C. and about 72° C. (e.g., about 37° C., about 65° C., about 72° C., or from about 37° C. to about 72° C.). In some embodiments, the aqueous reaction mixture comprises nucleic acid and protein. In some embodiments, the aqueous reaction mixture comprises DNA and a DNA- or RNA-dependent DNA polymerase. In some embodiments the polymerase is heterologous to the DNA. In some embodiments, the method comprises performing reverse transcription in the aqueous reaction mixture. In some embodiments, the method comprises performing nucleic acid amplification in the aqueous reaction mixture. In some embodiments, the aqueous reaction mixture comprises an antibody or antibody fragment and a target antigen, wherein the antibody or antibody fragment specifically binds the target antigen.

In another aspect, the present invention provides a system for low volume liquid handling of an aqueous reaction mixture, the system comprising: i) an array of reaction chambers comprising a plurality of individual compositions, the individual compositions containing a low volume aqueous reaction mixture and a first immiscible liquid, wherein the combined volume of the aqueous reaction mixture and first immiscible liquid is at least about 5 μL and no more than about 50 μL; and ii) an array of pipettes, wherein the system is configured to maintain the plurality of low volume aqueous reaction mixtures at a temperature of about 65° C. for a duration of between about 10 minutes and 48 hours (e.g., about 10 minutes, about 48 hours, or from about 10 minutes to about 48 hours). In some embodiments, the system is configured to maintain the plurality of low volume aqueous reaction mixtures at a temperature of about 65° C. for a duration of between about 10 minutes and 1 hour (e.g., about 10 minutes, about 1 hour, or from about 10 minutes to 1 about hour). In some embodiments, the system is configured to combine the plurality of compositions containing the aqueous reaction mixtures with a plurality of solutions comprising beads functionalized with affinity agents.

In another aspect, the present invention provides a system for low volume liquid handling of an aqueous reaction mixture, the system comprising: i) an array of reaction chambers containing a plurality of individual compositions, the individual compositions containing a low volume aqueous reaction mixture, a first immiscible liquid, and a second immiscible liquid, wherein the first immiscible liquid is less dense than the aqueous reaction mixture and the second immiscible liquid is more dense than the aqueous reaction mixture; and ii) an array of pipettes.

In another aspect, the present invention provides a composition comprising a volume of an aqueous reaction mixture, a volume of a first immiscible liquid, and a volume of a second immiscible liquid, wherein the volume of the aqueous reaction mixture is at least 0.5 μL and not more than 5 μL; the first immiscible liquid is less dense than the aqueous reaction mixture and has a volume of at least three times the volume of the aqueous reaction mixture; and the second immiscible liquid is more dense than the aqueous reaction mixture and has a volume of at least three times the volume of the aqueous reaction mixture. In some embodiments, the aqueous reaction mixture comprises nucleic acid. In some embodiments, the aqueous reaction mixture comprises deoxyribonucleic acid (DNA). In some embodiments, the aqueous reaction mixture comprises ribonucleic acid (RNA). In some embodiments, the aqueous reaction mixture comprises nucleic acid and protein. In some embodiments, the aqueous reaction mixture comprises DNA and a DNA- or RNA-dependent DNA polymerase.

In another aspect, the present invention provides a method of low volume liquid handling comprising: (a) combining in a first container a volume of an aqueous reaction mixture, a volume of a first immiscible liquid, and a volume of a second immiscible liquid to produce a composition comprising the aqueous reaction mixture and the first and second immiscible liquids, wherein the volume of the aqueous reaction mixture is at least 0.1 μL and not more than 7 μL; the volume of the first immiscible liquid is at least three times the volume of the aqueous reaction mixture; the volume of the second immiscible liquid is at least three times the volume of the aqueous reaction mixture; and one of the first immiscible liquid and the second immiscible liquid is less dense than the aqueous reaction mixture and the other immiscible liquid is more dense than the aqueous reaction mixture; (b) incubating the a composition comprising the aqueous reaction mixture and the first and second immiscible liquids for at least 1 minute at a temperature of at least 25° C.; and (c) transferring substantially all of the composition in (b) to a second container.

In some embodiments, the volume of the aqueous reaction mixture is at least 0.5 μL and not more than 5 μL. In some embodiments, the aqueous reaction mixture comprises DNA and a DNA- or RNA-dependent DNA polymerase. In some embodiments, the method further comprises adding additional reagents to the second container. In some embodiments, the method comprises hybridizing in the aqueous reaction mixture labeled bait oligonucleotides to target nucleic acid fragments in the first container and immobilizing the hybridized target nucleic acid fragments and labeled bait oligonucleotides to beads functionalized with affinity reagents that specifically bind the label of the labeled bait oligonucleotides in the second container. In some embodiments, the method comprises performing a hybrid capture reaction in the first container to capture target nucleic acid fragments in the aqueous reaction mixture; and amplifying captured target nucleic acid fragments in the second container.

In some embodiments, the temperature of the aqueous reaction mixture is stable to within 10° C. during the transfer. In some embodiments, the first and second containers are incubated at a same temperature. In some embodiments, the first container is incubated at a first temperature and the second container is incubated at a second temperature.

In another aspect, the present invention provides a method of low volume liquid handling comprising transferring any one of the foregoing compositions from a first container to a second container, wherein substantially the entire composition is transferred. In some embodiments, the first container is a tube and the second container is a tube. In some embodiments, the method further comprises transferring any one of the foregoing compositions from the second container to a third container, wherein substantially the entire composition is transferred.

### DETAILED DESCRIPTION OF THE INVENTION

### I. Overview

As described herein, the inventors have developed improved methods, compositions, instrumentation, and systems for low volume liquid handling. These improved methods, compositions, instrumentation, and systems can be used in a wide variety of applications, including but not limited to, analysis of low volume nucleic acid samples.

In one aspect, the improved liquid handling is provided by combining a volume of an immiscible liquid with volume of an aqueous reaction mixture to produce a larger total volume while retaining the advantages of the small aqueous reaction mixture volume (e.g., increased throughput and/or decreased reagent use). The larger total volume can reduce sample loss, reduce evaporation, increase thermal inertia for samples and processes that benefit from stable temperature control, or a combination thereof.

In some cases, the immiscible liquid is less dense than the aqueous reaction mixture and thus “floats” on the surface of the reaction. In some cases, the immiscible liquid is more dense than the aqueous reaction mixture and thus resides on the bottom of the aqueous reaction mixture. In another aspect, the improved liquid handling is provided by the combining a volume of an aqueous reaction mixture with two different immiscible liquids to form a tri- or multi-phase composition comprising an aqueous reaction mixture sandwiched between a first immiscible liquid layer and a second immiscible liquid layer.

### III. Definitions

As used herein, the term “aqueous reaction mixture” refers to a solution containing water and one or more components of a reaction mixture. Such components include, but are not limited to, buffering agents, molecular crowding agents, salts, proteins, modified and/or unmodified nucleic acids, and enzymes, or combinations thereof. For purposes of this disclosure, the density of an aqueous reaction mixture is substantially the same as the density of water (1 g/cm³ at 4° C.). An aqueous reaction mixture means an acellular mixture of heterologous components.

As used herein, the term “immiscible liquid” refers to a liquid having a solubility in water of less than 100 parts per billion (ppb). In some cases, immiscible liquid also refers to a liquid having a solubility in a second mutually immiscible liquid of less than about 10% (w/w, w/v, or v/v), or less than 1% (w/w, w/v, or v/v). The relative immiscibility of a pair of liquid solvents, or of each component of a three-phase system, can be empirically determined, or can be estimated using various solubility parameters. For example, the Hildebrand solubility parameter can be used to estimate the relative immiscibility of liquids, where a large difference (e.g., at least 5, 10, 15, or 20 MPa) between liquids can indicate mutual immiscibility. See, e.g., Adams D., Dyson; P., Tavener, S. Chemistry in Alternative Reaction Media 2004, John Wiley & Sons, incorporated herein by reference.

As used herein, the term “more dense” in the context of a density of an immiscible liquid in comparison to an aqueous reaction mixture refers to an immiscible liquid that is at least 25% more dense than water in terms of g/cm³ at the same temperature and pressure.

As used herein, the term “less dense” in the context of a density of an immiscible liquid in comparison to an aqueous reaction mixture refers to an immiscible liquid that is less than about 99% of the density of water in terms of g/cm³ at the same temperature and pressure.

As used herein, the term volumetric capacity refers to a working volume of a tube or well. For example, a microcentrifuge tube typically has a volumetric capacity of 2.0, 1.7, 1.5, 0.5, or 0.2 mL.

As used herein, the term “immiscible organic solvent” refers to a water immiscible organic liquid. Suitable organic solvents include distillation products or hydrocarbon mixtures such as, for example, mineral oil and/or other paraffin oils that contain mainly long-chain alkyl polymers with preferably 13 to 20, or 14 to 16 carbon atoms. Hydrocarbons within the meaning of the invention are understood to be in the first instance branched or unbranched hydrocarbons that have 5 to 20, preferably 6 to 18, more preferably 8 to 12 carbon atoms. Most particularly preferred branched or unbranched alkyls with 8 to 12 carbon atoms are used, of which octane, nonane, decane and/or dodecane as well as mixtures thereof are especially preferred. The branched or unbranched alkyls can be substituted (e.g., multiply substituted) as described below.

As used herein, the term “siloxane” refers to a compound comprising branched or unbranched chains of alternating silicon and oxygen atoms, wherein each silicon atom is separated from its nearest silicon neighbor by a single oxygen atom. The term “siloxane” as referred to herein further comprises the term “polysiloxane.” An example of a polysiloxane can be represented by the following formula:

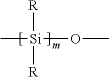

wherein R is a straight-chain alkyl group, a branched alkyl group, a substituted alkyl group, an aryl group, or a substituted aryl group, and m is an integer ranging from 5 to 200, preferably 6-12. An example of a polysiloxane compound is polydimethylsiloxane, wherein R is a methyl group. In some cases, the polysiloxane is a cyclic siloxane. Exemplary cyclic siloxanes include, but are not limited to, hexa-, octa-, deca-, and dodecamethylcyclohexasiloxane.

As used herein, the term “silicone oil” refers to a polymeric siloxane or a mixture of polymeric siloxanes. An exemplary silicone oil is polydimethylsiloxane. Additional silicone oils, are known in the art. See, e.g., www.amchro.com/PDFs/Silane/SC5-SILICONES_INTRODUCTION.pdf. In some cases, the silicon oil is a combination of polymeric siloxanes.

As used herein, the term “fluorocarbon polymer” in the context of an immiscible liquid containing such refers to an organic (e.g., alkyl, cycloalkyl, aryl, alkoxy, etc.) polymer in which at least one hydrogen in a carbon-hydrogen bond is substituted with a fluorine. As used herein, the term “immiscible liquid comprising a fluorocarbon polymer,” and the like, refers to an immiscible liquid containing either a single fluorocarbon polymer or a mixture of fluorocarbon polymers, optionally in combination with hydrocarbon polymers, silicone oils, or other organic solvents. Exemplary immiscible liquids containing a fluorocarbon polymer include those containing a perfluoroalkane, a perfluoroether, a perfluoroamine, perfluorohexane, perfluoroheptane, perfluorooctane, perfluoromethylcyclohexane, and the like. As used herein, the term “perfluoro” refers to a compound where all the hydrogens are replaced with fluorine. For example, perfluorooctane refers to the compound of formula C₈F₁₈. Additional fluorocarbon polymers include those described in WO 2005/117,850; WO 2009/133,575; and U.S. Pat. No. 6,262,126, the contents of which are incorporated by reference in the entirety.

As used herein the term “alkyl” refers to C₁₋₂₀ inclusive, linear, branched, or cyclic, saturated or unsaturated (i.e., alkenyl and alkynyl)hydrocarbon chains, including for example, methyl, ethyl, propyl, isopropyl, butyl, isobutyl, tert-butyl, pentyl, hexyl, octyl, ethenyl, propenyl, butenyl, pentenyl, hexenyl, octenyl, butadienyl, propynyl, butynyl, pentynyl, hexynyl, heptynyl, and allenyl groups. “Branched” refers to an alkyl group in which a lower alkyl group, such as methyl, ethyl, propyl, or butyl group, is attached to a linear alkyl chain. “Lower alkyl” refers to an alkyl group having 1 to about 8 carbon atoms, e.g., an alkyl group of 1, 2, 3, 4, 5, 6, 7 or 8 carbons (i.e., a C₁₋₈ alkyl). “Higher alkyl” refers to an alkyl group having about 10 to about 20 carbon atoms, e.g., alkyl groups of 10, 11, 12, 13, 14, 15, 16, 17, 18, 19 or 20 carbons. In some embodiments, “alkyl” refers, in particular, to C₁₋₈ linear alkyls. In other embodiments, alkyl refers, in particular, to C₁₋₈, branched-chain alkyls. The term “alkylated” refers to a chemical compound containing one or more alkyl groups.

Alkyl groups can optionally be substituted with one or more alkyl group substituents, which can be the same or different. The term “alkyl group substituent” includes but is not limited to alkyl, halo, arylamino, acyl, hydroxyl, aryloxyl, alkoxyl, alkylthio, arylthio, aralkyloxyl, aralkylthio, carboxyl, alkoxycarbonyl, oxo, and cycloalkyl. There can be optionally inserted along the alkyl chain one or more oxygen, sulfur or substituted or unsubstituted nitrogen atoms, wherein the nitrogen substituent is hydrogen, lower alkyl (also referred to herein as “alkylaminoalkyl”), or aryl.

The term “aryl” is used herein to refer to an aromatic substituent that can be a single aromatic ring, or multiple aromatic rings that are fused together, linked covalently, or linked to a common group such as a methylene or ethylene moiety. The common linking group also can be a carbonyl as in benzophenone or oxygen as in diphenylether or nitrogen as in diphenylamine. The term “aryl” specifically encompasses heterocyclic aromatic compounds. The aromatic ring(s) can comprise phenyl, naphthyl, biphenyl, diphenylether, diphenylamine and benzophenone, among others. In particular embodiments, the term “aryl” means a cyclic aromatic comprising about 5 to about 10 carbon atoms, and including 5- and 6-membered hydrocarbon and heterocyclic aromatic rings.

The aryl group can be optionally substituted with one or more aryl group substituents which can be the same or different, where “aryl group substituent” includes alkyl, aryl, aralkyl, hydroxyl, alkoxyl, aryloxyl, aralkyloxyl, carboxyl, acyl, halo, nitro, alkoxycarbonyl, aryloxycarbonyl, aralkoxycarbonyl, acyloxyl, acylamino, aroylamino, carbamoyl, alkylcarbamoyl, dialkylcarbamoyl, arylthio, alkylthio, alkylene, and —NR′R″, where R′ and R″ can be each independently hydrogen, alkyl, aryl, and aralkyl.

Specific examples of aryl groups include but are not limited to cyclopentadienyl, phenyl, furan, thiophene, pyrrole, pyran, pyridine, imidazole, benzimidazole, isothiazole, isoxazole, pyrazole, pyrazine, triazine, pyrimidine, quinoline, isoquinoline, indole, carbazole, and the like.

The term “aromatic” refers to an organic compound containing one or more unsaturated carbon rings characteristic of the benzene series and related organic groups.

The term “alkoxylated” refers to a chemical compound containing one or more alkoxyl groups as defined herein. The term “alkoxyl” refers to an alkyl-O— group, wherein alkyl is as previously described. The term “alkoxyl” as used herein can refer to C₁₋₂₀ inclusive, e.g., a hydrocarbon chain of 1, 2, 3, 4, 5, 6, 7, 8, 9, 10, 11, 12, 13, 14, 15, 16, 17, 18, 19 or 20 carbons, linear, branched, or cyclic, saturated or unsaturated oxo-hydrocarbon chains, including, for example, methoxy, ethoxy, propoxy, isopropoxy, butoxy, t-butoxy, and pentoxy. In some embodiments, the alkoxylated polysiloxane is an ethoxylated polysiloxane.

As used herein, the term “DNA dependent DNA polymerase” refers to an enzyme that, under the appropriate reaction conditions synthesizes a DNA polymer from a DNA template. Similarly, an “RNA-dependent DNA polymerase” refers to a reverse transcriptase enzyme that synthesizes a DNA polymer from an RNA template.

As used herein, the term “heterologous” refers to two or more components that are not found together in nature. For example, a polymerase naturally produced by a thermophilic organism and a mammalian nucleic acid template are heterologous.

As used herein, the term “pipette” refers to a laboratory tool commonly used in chemistry, biology and medicine to transport a measured volume of liquid. As used herein, the term “pipette tip” refers to a removable and reusable or disposable container that comes in contact with the liquid. Liquid is transported by loading the liquid into and/or dispensing the liquid out of the pipette tip.

As used herein, the term “affinity agent” refers to an molecule that specifically binds a ligand, such as a label of a labeled oligonucleotide. Exemplary affinity agents include, but are not limited to, avidin, streptavidin, an antibody, an antibody fragment, or an aptamer.

As used herein, the term “about” is used herein to modify a numerical value, such that if “X” is the value, “about X” indicates a value from 0.9X to 1.1X.

### III. Compositions

Described herein are immiscible liquids that are immiscible with aqueous reaction mixtures. Generally, the immiscible liquids do not interfere with reactions occurring in the aqueous phase, as well as downstream processes, and have a vapor pressure and/or boiling point greater than the aqueous phase. In some embodiments, where two different immiscible liquids are present or employed, the two different immiscible liquids are immiscible with respect to both the aqueous reaction mixture and with each other. Such pairs of two different immiscible liquids are referred to as “mutually immiscible.” In other embodiments, the two different immiscible liquids are immiscible with an aqueous reaction mixture, but at least partially, or entirely, miscible with each other. Such pairs of two different immiscible liquids that are miscible with each other are referred to as “non-mutually immiscible.” In some cases, where two different non-mutually immiscible liquids are utilized, separation between the non-mutually immiscible liquids is maintained by an intervening aqueous layer (e.g., the aqueous reaction mixture), a difference in density between the non-mutually immiscible liquids, or a combination thereof.

A. Immiscible Liquids that are Less Dense than Water

Immiscible liquids that are less dense than water may be, without limitation, less than about 99%, less than about 97%, less than about 95%, less than about 90%, less than about 85%, less than about 80%, or less than about 75% of the density of water in terms of g/cm³ at the same temperature and pressure (e.g., one atmosphere at 25° C.). Such immiscible liquids can be used as a “top layer” of an aqueous reaction mixture containing composition. Without wishing to be bound by theory, it is hypothesized that the strong attraction of water to itself, and/or the attraction of an immiscible liquid to itself, allows compositions containing less dense immiscible liquids having a similar density to water (e.g., within 0.5, 1, 2, 3, or 5%) to readily form a robust top layer on an aqueous reaction mixture.

Various suitable immiscible liquids can be employed as the top layer of an aqueous reaction mixture. Suitable examples include, but are not limited to liquids containing or consisting of immiscible organic solvent, mineral oil, silicone oil, fluorocarbon polymer, or a combination thereof.

A suitable top-layer immiscible liquid can be characterized by the one or more, or all, physico-chemical properties described herein. Typically, the suitable top-layer immiscible liquid is chemically inert with respect to components of the aqueous reaction mixture, a bottom, non-aqueous, immiscible layer if present, and the conditions in which it is utilized. Accordingly, the top-layer immiscible liquid can be resistant to hydrolysis or decomposition by acids in bases in a pH range of at least about 2 to less than about 14, preferably about 3 to about 12, more preferably from about 4 to about 9, or from about 6.5 to about 8.5. Similarly, the top-layer immiscible liquid can be resistant to thermal decomposition. For example, the top-layer can be resistant (e.g., entirely resistant) to thermal decomposition at temperatures of less than about 300° C., less than about 200° C., less than about 150° C., or less than about 100° C.

Additional physico-chemical properties to be considered in selecting a suitable top-layer immiscible liquid include boiling point, flash point, freeze point, viscosity, vapor pressure, and the like. In some cases the boiling point of the top-layer immiscible liquid is selected to be at least above 65° C., at least above 95° C., at least above 100° C., or at least above 120° C. High boiling point (e.g., >65° C. or >120° C., or more) top-layer immiscible liquids are preferred for aqueous reactions that are performed at elevated temperature (e.g., >50° C.). In some cases, the flash point of the top-layer immiscible liquid is selected to be at least above 95° C., at least above 100° C., at least above 120° C., or at least above 125° C. In some cases, the top-layer immiscible liquid is flame or ignition resistant.

In some cases, the freeze point of the top-layer immiscible liquid is selected to be at least below 25° C., at least below 10° C., or at least below 0° C. In some cases, a freeze point higher than the aqueous reaction mixture (e.g., about 25° C., 10° C., 4° C., etc.) is selected to allow solidification of the top immiscible layer during one or more processing or downstream processing steps. Such solidification can be useful to form a contamination barrier between aqueous reaction mixtures and/or stock reagents. However, it is recognized that a contamination barrier is still provided by top-layer immiscible liquid in a non-solidified liquid state.

In some cases, the viscosity of the top-layer immiscible liquid is selected to facilitate pipetting, dispensing, or spreading of the top layer over the aqueous reaction mixture, or a combination thereof. Accordingly, the top-layer immiscible liquid is typically selected to have a viscosity of less than about 500 cSt, less than about 300 cSt, less than about 200 cSt, less than about 100 cSt, less than about 50 cSt, less than about 25 cSt, less than about 10 cSt, less than about 5 cSt, less than about 1 cSt, or less than about 0.5 cSt at, e.g., 25° C. Procedures for measuring viscosity of a top-layer immiscible liquid include, e.g., those described in ASTM D445 and ISO 3104.

In some cases, the vapor pressure of the top-layer immiscible liquid is selected to be resistant to evaporation during aqueous reaction mixture processing steps. Accordingly, the top-layer immiscible liquid is typically selected to have a vapor pressure of at a specified temperature and atmospheric pressure of less than about 20 mm Hg, less than about 15 mm Hg, less than about 10 mm Hg, less than about 5 mm Hg, less than about 2 mm Hg, or less than about 1 mm Hg. In some cases, the selected vapor pressure refers to the vapor pressure at one atmosphere and 15° C., 20° C., 25° C., 30° C., or 37.8° C.

In some cases, the aqueous reaction mixture, or components therein, can be subjected to one or more spectroscopic and/or fluorometric assays, e.g., in the presence of a top-layer immiscible liquid, or in a downstream process. In such cases, a suitable top-layer immiscible liquid can be selected to have minimal interference with such assays. For example, the top-layer immiscible liquid can be selected to be transparent in the ultraviolet, visible, or near infrared range, or a combination thereof. Similarly, the top-layer immiscible liquid can be selected to have no, or minimal, autofluorescence.

In an exemplary embodiment, the top-layer immiscible liquid has density of less than 1.00 g/cm³ at standard temperature and pressure, a solubility in water of less than 100 ppb, a flash point of greater than 125° C., a boiling point of greater than about 120° C., a viscosity of greater than or equal to about 5 cSt (e.g., at 25° C.), a vapor pressure of less than about 1 mm Hg (e.g., at 25° C.), and exhibits minimal absorbance in the visible range and minimal autofluorescence in the excitation range from 36-680 nm and emission range from 460-712 nm. In another exemplary embodiment, the top-layer immiscible liquid is Qiagen VAPOR-LOCK®, a high molecular weight hydrophobic polymer. In another exemplary embodiment, the top-layer immiscible liquid is or contains a fluoropolymer. For example, the top-layer immiscible liquid can be, or can contain, 1-fluoroheptane, 1-fluorooctane, or a combination thereof. In another exemplary embodiment, the top-layer immiscible liquid is or contains a polysiloxane, such as polydimethylsiloxane having a viscosity of 5 cSt, 10, 20 cSt, or 100 cSt at 25° C.

The top-layer immiscible liquid can be present in an aqueous reaction mixture containing composition at a volume of about 1.0 μL to about 100 μL, about 1.5 μL to about 75 μL, about 2 μL to about 50 μL, about 5 μL to about 40 μL, about 7.5 μL to about 30 μL, or about 10 μL to about 25 μL. In some cases, the top-layer immiscible liquid can be present in an aqueous reaction mixture containing composition at a volume of about 5, 6, 7, 8, 9, 10, 11, 12, 13, 14, 15, 16, 17, 18, 19, 20, 21, 22, 23, 24, 25, 26, 27, 29, 30, 31, 32, 33, 34, or 35 μL. In some cases, the volume of the top-layer immiscible liquid in an aqueous reaction mixture containing composition is at least about 2 times, at least about 3 times, at least about 4 times, or at least about 5 times, or more than 5 times the volume of the aqueous reaction mixture. Typically, a suitable minimum volume of the top-layer immiscible liquid is selected that can at least cover the top surface of the aqueous reaction mixture. In such cases, the minimum volume can depend upon the presence or absence of a bottom-layer, the volume of the aqueous reaction mixture, and the geometry of the container containing the composition (e.g., tube, well, or pipette).

A suitable top-layer immiscible liquid volume can be relative to a volume of a bottom-layer immiscible liquid in an composition containing aqueous reaction mixture and top- and bottom-layer immiscible liquids. In some cases, the top-layer immiscible liquid is from about 0.25 times the volume of a bottom-layer immiscible liquid to about 10 times the volume of the bottom-layer immiscible liquid. In some cases, the top-layer immiscible liquid is from about 0.5 times the volume of a bottom-layer immiscible liquid to about 5 times the volume of the bottom-layer immiscible liquid. In some cases, the top-layer immiscible liquid is from about 0.75 times the volume of a bottom-layer immiscible liquid to about 2 times the volume of the bottom-layer immiscible liquid. In some cases, the volume of the top-layer is the same or substantially the same (e.g., within about 10% or less, about 5% or less, or about 1% or less) volume of a bottom-layer immiscible liquid.

B. Immiscible Liquids that are More Dense than Water

Described herein are immiscible liquids that are more dense than water. Such immiscible liquids can be used as a “bottom-layer” of an aqueous reaction mixture containing composition. Various suitable immiscible liquids can be employed as the bottom layer of an aqueous reaction mixture. Suitable examples include, but are not limited to liquids containing or consisting of immiscible organic solvent, mineral oil, silicone oil, fluorocarbon polymer, or a combination thereof.

A suitable bottom-layer immiscible liquid can be characterized by the one or more, or all, physico-chemical properties described herein. Typically, the suitable bottom-layer immiscible liquid is chemically inert with respect to components of the aqueous reaction mixture, a top, non-aqueous, immiscible layer if present, and the conditions in which it is utilized. Accordingly, the bottom-layer immiscible liquid can be resistant to hydrolysis or decomposition by acids in bases in a pH range of at least about 2 to less than about 14, preferably about 3 to about 12, more preferably from about 4 to about 9, or from 6.5 to about 8.5. Similarly, the bottom-layer immiscible liquid can be resistant to thermal decomposition. For example, the bottom-layer can be resistant to thermal decomposition at temperatures of less than about 300° C., less than about 200° C., less than about 150° C., or less than about 100° C. In some cases, the bottom-layer immiscible liquid can be resistant to thermal decomposition up to about 200, 250, 300, 400, or 500° C.

Additional physico-chemical properties to be considered in selecting a suitable bottom-layer immiscible liquid include boiling point, flash point, freeze point, viscosity, vapor pressure, and the like. In some cases the boiling point of the bottom-layer immiscible liquid is selected to be at least above 65° C., at least above 95° C., at least above 100° C., or at least above 120° C. In some cases, the flash point of the bottom-layer immiscible liquid is selected to be at least above 95° C., at least above 100° C., at least above 120° C., or at least above 125° C. In some cases, the freeze point of the bottom-layer immiscible liquid is selected to be at least below 25° C., at least below 10° C., or at least below 0° C.

In some cases, the viscosity of the bottom-layer immiscible liquid is selected to be facilitate pipetting, dispensing, or flow of the bottom layer under the aqueous reaction mixture, or a combination thereof. Accordingly, the bottom-layer immiscible liquid is typically selected to have a viscosity of less than about 500 cSt, less than about 300 cSt, less than about 200 cSt, less than about 100 cSt, less than about 50 cSt, less than about 25 cSt, less than about 10 cSt, less than about 5 cSt, less than about 1 cSt, or less than about 0.5 cSt at 25° C. Procedures for measuring viscosity of a bottom-layer immiscible liquid include, e.g., those described in ASTM D445 and ISO 3104.

In some cases, the vapor pressure of the bottom-layer immiscible liquid is selected to be resistant to evaporation during aqueous reaction mixture processing steps. Accordingly, the bottom-layer immiscible liquid is typically selected to have a vapor pressure of at a specified temperature and atmospheric pressure of less than about 20 mm Hg, less than about 15 mm Hg, less than about 10 mm Hg, less than about 5 mm Hg, less than about 2 mm Hg, or less than about 1 mm Hg. In some cases, the selected vapor pressure refers to the vapor pressure at one atmosphere and 15° C., 20° C., 25° C., 30° C., or 37.8° C.

In some cases, the aqueous reaction mixture, or components therein, can be subjected to one or more spectroscopic and/or fluorometric assays, e.g., in the presence of a bottom-layer immiscible liquid, or in a downstream process. In such cases, a suitable bottom-layer immiscible liquid can be selected to have minimal interference with such assays. For example, the bottom-layer immiscible liquid can be selected to be transparent in the ultraviolet, visible, or near infrared range, or a combination thereof. Similarly, the bottom-layer immiscible liquid can be selected to have no, or minimal, autofluorescence.

In an exemplary embodiment, the bottom-layer immiscible liquid has a density of about 1.78 g/cm³ at 25° C., a solubility in water of less than 100 ppb, a flash point of greater than 125° C., a boiling point of about 103° C., a viscosity of about 0.8 cSt (e.g., at 25° C.), a vapor pressure of less than about 56 mm Hg (e.g., at 25° C.), and exhibits minimal absorbance in the visible range and autofluorescence in the excitation range from 36-680 nm and emission range from 460-712 nm. In another exemplary embodiment, the bottom-layer immiscible liquid is perfluorooctane, or perfluorononane.

The bottom-layer immiscible liquid can be present in an aqueous reaction mixture containing composition at a volume of about 1.0 μL to about 100 μL, about 1.5 μL to about 75 μL, about 2 μL to about 50 μL, about 5 μL to about 40 μL, about 7.5 μL to about 30 μL, or about 10 μL to about 25 μL. In some cases, the bottom-layer immiscible liquid can be present in an aqueous reaction mixture containing composition at a volume of about 5, 6, 7, 8, 9, 10, 11, 12, 13, 14, 15, 16, 17, 18, 19, 20, 21, 22, 23, 24, 25, 26, 27, 29, 30, 31, 32, 33, 34, or 35 μL. In some cases, the volume of the bottom-layer immiscible liquid in an aqueous reaction mixture containing composition is about 2 times, about 3 times, about 4 times, or about 5 times or more the volume of the aqueous reaction mixture. In some cases, a suitable minimum volume of the bottom-layer immiscible liquid is selected that can at least prevent the bottom surface of the aqueous reaction mixture from contacting the bottom surface of a container (e.g., tube, well, or pipette) in which the aqueous reaction mixture is contained. In such cases, the minimum volume can depend upon the presence or absence of a top-layer, the volume of the aqueous reaction mixture, and the geometry of the container containing the composition.

C. Aqueous Reaction Mixtures

Described herein are compositions containing low volume aqueous reaction mixtures and one or more immiscible liquids. A wide variety of aqueous reaction mixtures can be used in the compositions, methods, and systems described herein. Typically, the aqueous reaction mixture, and components therein, can be selected to perform a desired reaction in a low volume.

A suitable aqueous reaction mixture, and the components therein, can be characterized by one or more bulk physico-chemical properties such as pH, ionic strength, volume, temperature, or chemical compatibility with the one or more immiscible liquid layers in which it is in contact. A suitable pH of the aqueous reaction mixture includes any pH range of at least about 2 to less than about 14, preferably about 3 to about 12, more preferably from about 4 to about 9, or from about 6.5 to about 8.5. In some cases, the pH of the aqueous reaction mixture is selected to be compatible with an enzymatic, physical, or chemical reaction occurring therein. For example, if the reaction of the aqueous reaction mixture is nucleic acid amplification with Taq polymerase, a pH of from about 7 to about 8.5, preferably 8 can be selected, alternatively, the pH can be about 7.2. As another example, if the reaction of the aqueous reaction mixture is nucleic acid hybridization, a pH of, e.g., about 7 can be selected.

A suitable aqueous reaction mixture ionic strength can be from about 0 mM (i.e., no significant dissolved ions) to about 750 mM, from about 10 mM to about 750 mM, from about 25 mM to about 750 mM, from about 50 mM to about 300 mM, or from about 100 to about 250 mM. In some cases, the ionic strength of the aqueous reaction mixture is from about 0 mM to about 500 mM, from about 10 mM to about 500 mM, or from about 25 mM to about 500 mM. In some cases, the ionic strength of the aqueous reaction mixture is about 10 mM, 15 mM, 20 mM, 30 mM, 40 mM, 50 mM, 75 mM, 100 mM, 150 mM, 200 mM, 250 mM, 300 mM, 350 mM, or 400 mM. The ionic strength of the aqueous reaction mixture can be provided by a wide variety of suitable salts, including but not limited to alkali metal halides (e.g., NaCl), alkaline earth metal halides (e.g., MgCl₂), sulfates (e.g., MgSO₄), phosphates (e.g., mono and/or dibasic sodium phosphate), and the like.

The volume of the aqueous reaction mixture can be from about 0.5 μL to about 5 μL, from about 0.75 μL to about 5 μL, from about 0.5 μL to about 3 μL, from about 0.75 μL to about 3 μL, from about 1 μL to about 4 μL, from about 1 μL to about 3 μL, or about 2 μL. In some cases, the volume of the aqueous reaction mixture is less than about ¾, ⅔, ½, ⅓, ¼, or ⅕, or about the same as a volume of a top-layer immiscible liquid of a composition in which it is present. In some cases, the volume of the aqueous reaction mixture is less than about ¾, ⅔, ½, ⅓, ¼, or ⅕, or about the same as a volume of a bottom-layer immiscible liquid of a composition in which it is present.

The components of the aqueous reaction mixture, aside from water itself, can be selected to perform or promote an enzymatic, physical, or chemical reaction occurring therein. For example, the aqueous reaction mixture can contain an enzyme and substrate for performing an enzymatic reaction. In some cases, salts (e.g., Mg or Mn) or co-factors (e.g., NADH) can be included for enzymatic activity. In some cases, the enzyme is a DNA polymerase and the aqueous reaction mixture further contains a nucleic acid template and dNTPs. In some cases, the enzyme is a DNA-dependent DNA polymerase and the aqueous reaction mixture contains a DNA template, dNTPs, and optionally one or more primers. In some cases, the enzyme is an RNA-dependent DNA polymerase and the aqueous reaction mixture contains an RNA template, dNTPs, and optionally one or more primers. Typically, where a DNA polymerase and a nucleic acid template are components of the aqueous reaction mixture, the DNA polymerase is heterologous to the nucleic acid template. Exemplary reactions and processes include nucleic acid hybridization, amplification, hybrid capture, ligation, library construction, reverse transcription, DNA sequencing reactions, and multiplex ligation-dependent probe amplification.

In some cases, the aqueous reaction mixture is a low volume hybrid capture reaction for enriching a nucleic acid sample for target nucleic acids from a background of non-target genomic nucleic acid fragments or cDNA. Hybrid capture reactions, as well as other target enrichment strategies, are generally known in the art and are described, e.g., in U.S. Pat. No. 8,288,520; WO 2014/008,447; and Mamanova et al., Nat. Methods, 7:111-118 (2010), the contents of which are incorporated by reference in the entirety for all purposes. In such cases, the aqueous reaction mixture can contain one or more, or all, of a plurality of target nucleic acids, a plurality of non-target nucleic acids, a plurality of labeled DNA or RNA bait oligonucleotides complementary to target nucleic acids, or blocking DNA/RNA (e.g., COT-1 DNA®, blocking oligonucleotides, or a combination thereof) under conditions suitable for hybrid capture. Typical hybrid capture conditions include, but are not limited to 2% Dextran Sulphate, 4% SSPE, 4% Denhardt's Solution, 0.004 M EDTA, 0.08% SDS, 0.0004% Tween 20, and 5% Tetramethylammonium Chloride at 65° C.

Compositions containing aqueous reaction mixtures described herein that contain one or more biological components, such as biological lipids, fatty acids, long-chain polymers, proteins (e.g., enzymes, antibodies, or antibody fragments), carbohydrates, salts, or nucleic acids and no more than one immiscible liquid exclude immiscible liquids of the lipid bilayers of an intact cell, cell extract, organelle, or organelle extract unless the immiscible liquid is heterologous to at least one of the other biological components.

D. Reaction Chambers and Other Containers

Compositions described herein, such as those containing an aqueous reaction mixture and one or more mutually immiscible liquids (e.g., a top-layer and a bottom-layer) can be contained in a variety of reaction chambers and other containers. Typically, the container is selected to be suitable for the volume and conditions of the composition. For example, a composition containing a 2 μL aqueous reaction mixture and a 25 μL top-layer immiscible liquid can be suitably contained in a container having a volumetric capacity of about 30 μL; 50 μL; 100 μL; 150 μL; 200 μL; 360 μL; 500 μL; 750 μL; 1 mL; 1.5 mL, 1.7 mL, or 2 mL. Similarly, a composition containing a 2 μL aqueous reaction mixture, a 25 μL top-layer immiscible liquid, and a 10 μL bottom-layer immiscible liquid can be suitably contained in a container having a volumetric capacity of about 40 μL; 50 μL; 100 μL; 150 μL; 200 μL; 360 μL; 500 μL; 750 μL; 1 mL; 1.5 mL, 1.7 mL, or 2 mL.

In some cases, for aqueous reaction mixture volumes within the lower range of those described herein, a preferable range of container volumetric capacities can include from about 10 μL to about 20 μL. In some cases, for larger aqueous reaction mixture volumes within the range of those described herein, a preferable range of container volumetric capacities can include from about 20 μL to about 100 μL, from about 20 μL to about 50 μL, from about 30 μL to about 50 μL, or from about 50 μL to about 100 μL. In some cases, for even larger reaction mixture volumes within the range of those described herein, a preferable range of container volumetric capacities can include from about 200 μL to about 500 μL, from about 200 μL to about 750 μL, from about 200 μL to about 1 mL, or from about 1 mL to 2 mL.

The container can be, for example and without limitation, a well (e.g., a well of a multiwell plate, e.g., a 96-, 384- 1536- or 3456 well microplate, a microcentrifuge tube (e.g., a 0.2 mL, 0.5 mL, 1.5 mL, 1.7 mL, or 2 mL microcentrifuge tube), a “PCR-tube” (e.g., a thin walled 0.2 mL, or 0.5 mL tube), or a disposable pipette tip (e.g., a P2, P10, P20, P50, P100, P200, or P1000 pipette tip).

E. Reaction Conditions

Compositions described herein, such as those containing a low volume aqueous reaction mixture and one or more mutually immiscible liquids (e.g., a top-layer and/or a bottom-layer) can be maintained at a relatively stable temperature during liquid handling as compared to a composition containing a low volume aqueous reaction mixture without a top-layer, without a bottom-layer, or without a top-layer and without a bottom-layer immiscible liquid. In some embodiments, the increased thermal inertia provided by the aqueous reaction mixture in combination with the one or more immiscible liquids, wherein the volume of each immiscible liquid is at least twice (e.g., about 2×, about 3×, about 4×, about 5×, or more) the volume of the aqueous reaction mixture, insulates the aqueous reaction mixture from unintentional, or unavoidable thermal perturbation. In some cases, the compositions described herein can be maintained at a temperature that is stable to within 1, 2, 3, 4, 5, 6, 7, 8, 9, 10, 11, 12, or 15° C. during liquid handling steps, e.g., using one or more of the method described herein. Temperature stability can, e.g., be measured using a micro-probe thermometer.

For example, an exemplary 2 μL aqueous reaction mixture (e.g., a hybrid capture reaction mixture) at 65° C. can be transferred from a first container to a second container containing beads functionalized to capture bait oligonucleotides using a pipette and tip by standard methods. In such cases, although care may be taken to maintain the temperature of the first and second containers at 65° C., the thermal inertia of the pipette tip can dramatically lower the temperature of the aqueous reaction mixture. Moreover, evaporation during the transfer step can also perturb the temperature of the aqueous reaction mixture. In comparison, an exemplary 37 μL composition containing a 2 μL aqueous reaction mixture and top- and bottom-layer immiscible liquids can be resistant to the thermal inertia of the pipette tip and evaporation, thus providing improved temperature control of the aqueous reaction mixture.

The temperature of the aqueous reaction mixture, and thus the composition further containing one or more immiscible liquids can be selected to be compatible with an enzymatic, physical, or chemical reaction occurring therein. For example, for isothermal nucleic acid amplification, the temperature can be selected to be suitable for the polymerase enzyme providing such amplification (e.g., 50° C., 65° C., or 72° C.). As another example, for reverse transcription, the temperature can be selected to be suitable for the RNA-dependent DNA polymerase enzyme providing reverse transcriptase activity (e.g., 25° C.-58° C., 37° C., 37° C.-42° C., 42° C., 42° C.-48° C., 50° C., 55° C., etc.) As another example, for nucleic acid amplification by polymerase chain reaction, the temperature can be selected to vary and thus be suitable for the denaturing (e.g., 95° C.), annealing (e.g., 55° C.), and extension (e.g., 68° C.) steps of the reaction, and the compositions and methods described herein can provide improved temperature stability at each target temperature. As yet another example, for nucleic acid hybridization, the temperature can be selected to be suitable for denaturing (e.g., 95° C.), sequence specific hybridization (e.g., 65° C.), or the combination thereof, and the methods and compositions described herein can provide improved temperature stability at each target temperature. In one embodiment, improved temperature stability at each target temperature is provided when aqueous reactions are transferred between different reaction vessels, each at an optimal temperature for, e.g., denaturing, hybridization, and immobilization onto solid substrates, respectively.

### IV. Methods

Described herein are methods for forming and using compositions containing a low volume aqueous reaction mixture and one or more immiscible liquids. Methods described herein can provide for quantitative or near quantitative handling of low volume aqueous reaction mixtures using macroscopic volume instrumentation and systems. Alternatively, or in addition, methods described herein can provide enhanced thermal control of the aqueous reaction mixture conditions.

A. Methods of Forming a Composition of the Invention

In one aspect, the method includes combining a volume of the aqueous reaction mixture and a volume of a first immiscible liquid to produce a composition containing the aqueous reaction mixture and the first immiscible liquid, wherein: the volume of the aqueous reaction mixture is at least 0.1 μL and not more than 10 μL; the volume of the first immiscible liquid is at least 2 to 15 times the volume of the aqueous reaction mixture; and the first immiscible liquid is less dense or more dense than the aqueous reaction mixture. In some cases, the aqueous reaction mixture is at least 0.5 μL and not more than 5 μL, or at least 1 μL and not more than 3 μL. In some cases, the aqueous reaction mixture is 2 μL. In some cases, the volume of the first immiscible liquid is at least 5 to 10 times the volume of the aqueous reaction mixture. In some cases, the volume of the first immiscible liquid is 5, 10, or 12.5 times the volume of the aqueous reaction mixture.

In some cases, the method further comprises combining the volume of the aqueous reaction mixture with a volume of a second immiscible liquid, wherein the volume of the second immiscible liquid is at least 2 to 15 times the volume of the aqueous reaction mixture; and one of the first immiscible liquid and the second immiscible liquid is less dense than the aqueous reaction mixture and the other immiscible liquid is more dense than the aqueous reaction mixture. In some cases, the volume of the second immiscible liquid is at least 5 to 10 times the volume of the aqueous reaction mixture. In some cases, the volume of the second immiscible liquid is 5, 10, or 12.5 times the volume of the aqueous reaction mixture. In some cases, the volume of the second immiscible liquid is 0.25, 0.4, 0.5, 1, 2, 3, 4, or 5 times the volume of the first immiscible liquid.

The aqueous reaction mixture can be combined with one or more immiscible liquids in a reaction chamber or other container. For example, the aqueous reaction mixture can be introduced into a reaction chamber and one or more immiscible liquids can then be further added to the chamber. As another example, a first immiscible liquid can be added to a reaction chamber followed by an aqueous reaction mixture and then a second immiscible liquid. As yet another example, a first immiscible liquid can be added to a reaction chamber, followed by an aqueous reaction mixture, and then followed by a second immiscible liquid. Due to the immiscibility of the one or more immiscible liquids with the aqueous reaction mixture and the relative densities of the three phases, the order in which the aqueous and non-aqueous phases are added into the reaction chamber is not critical, as the phases will rapidly settle to their respective top, bottom, and aqueous layers.

However, in some cases, it can be desirable to avoid contact, or substantial contact, of the aqueous reaction mixture, or components therein with the walls of a container. In such cases, contacting the container with a first and/or second immiscible liquid (e.g., a bottom- and/or top-layer immiscible liquid) prior to adding the aqueous reaction mixture can be advantageous.

B. Methods of Thermal Equilibration

In some cases, the methods for low volume liquid handling described herein include one or more steps of thermally equilibrating a container for an aqueous reaction mixture. Such methods can be useful for example in methods that include steps of loading, transferring, and/or dispensing reagents that are significantly different in temperature from the surrounding environment. For example, at room temperature (e.g., approximately 20 or 25° C.) the methods can be useful for loading, transferring, and/or dispensing cold (e.g., <15° C.), warm (e.g., >30° C.), or hot (e.g., 65° C. or 95° C.) reagents. Such cold, warm, or hot reagents can include an aqueous reaction mixture, a composition containing an aqueous reaction mixture, one or more aqueous reaction mixture components, and/or immiscible liquids.

In some cases, the method includes thermally equilibrating a dispensing container (e.g., disposable pipette tip) by contacting the container with a thermal equilibration fluid. In some cases, the method includes loading and dispensing a thermal equilibration fluid into the container, such as water or an immiscible liquid at a target temperature and then loading a reagent. In some cases, the loading and dispensing is performed twice or three times, or more. Such loading and dispensing can thermally equilibrate a dispensing container (e.g., a pipette tip) such that contact with the reagent does not substantially perturb the temperature of the reagent. Similarly, a reaction chamber can be thermally equilibrated by contacting with a thermal equilibration fluid prior to introducing an aqueous reaction mixture, a composition containing an aqueous reaction mixture, one or more aqueous reaction mixture components, and/or immiscible liquids, or a combination thereof.

In some cases, the method includes loading, transferring, and/or dispensing an aqueous reaction mixture with a pipette (e.g., a pipette and a disposable pipette tip), wherein the suggested working volume of the pipette is significantly larger than the volume of the aqueous reaction mixture. For example, an aqueous reaction mixture of about 2 μL can be loaded, transferred, and/or dispensed with a pipette (e.g., a pipette and a disposable pipette tip) having a working volume of about 50 μL (e.g., a P50 pipette tip) without significant (e.g., >10%) loss of sample. Such methods described herein can provide such quantitative or substantially quantitative loading, transferring, and/or dispensing because the total volume of the aqueous reaction mixture and one or more immiscible liquids is within the suggested working volume of the pipette.

Moreover, quantitative or substantially quantitative loading, transferring, and/or dispensing is further enhanced because the top-layer immiscible liquid, and optionally the bottom-layer immiscible liquid can act as wash and/or container-surface pre-wetting or blocking reagents during loading, transferring, and/or dispensing. Such wash, pre-wetting, or blocking can be provided by loading of pipettes from the bottom, or from near the bottom, of the aqueous reaction mixture containing composition. Such loading can aspirate bottom-layer immiscible liquid first, followed by aqueous reaction mixture, followed by top-layer immiscible liquid. Typically, the relative order of the phases of such an aqueous reaction mixture containing composition will rapidly equilibrate within a pipette tip during such bottom loading steps. Therefore, upon dispensing, the bottom-layer immiscible liquid can be dispensed first, followed by aqueous reaction mixture, followed by top-layer immiscible liquid. However, rapid equilibrium of phase separation is not a necessary requirement to obtain the quantitative or substantially quantitative loading, transferring, and/or dispensing provided by embodiments of the methods described herein.

C. Methods of Transfer

Described herein are methods of transferring small volume aqueous reaction mixtures, and methods of transferring reagents to or from small volume aqueous reaction mixtures. In some cases, the methods described herein provide improved stability of aqueous reaction mixture temperature, reduced sample loss, or require reduced processing time, or a combination thereof.

Compositions described herein can be further combined with additional reagents, e.g., after forming a two- or three-phase system. In one aspect, a hybrid capture aqueous reaction mixture containing a fragmented and adaptor ligated nucleic acid sample, labeled bait oligonucleotides, blocking oligonucleotides, and blocking DNA (e.g., COT-1 DNA®) can be combined with a first or a first and second immiscible liquid and incubated at a hybridization temperature (e.g., 65° C.) for a suitable period of time (e.g., 10, 20, 30, 45, or 60 minutes, or about 2-4, 4-6, 4-12, 8-24, or 12-48 hrs). The incubation at the hybridization temperature can be preceded by an incubation at a denaturation temperature.

In another aspect, a first aqueous reaction mixture containing fragmented and adaptor ligated nucleic acid sample, and optionally DNA blocking oligonucleotides, blocking DNA, or the combination thereof that is combined with a first or a first and second immiscible liquid (e.g., a top- and bottom-layer immiscible liquid) is incubated at a nucleic acid sample denaturation temperature (e.g., 95° C.) for a suitable period of time (e.g., 30 s, or 1, 5, 10, 20, 30, 45, or 60 minutes, or about 2-4, 4-6, 4-12, 8-24, or 12-48 hrs). Similarly, a second aqueous reaction mixture containing RNA bait oligonucleotides that is combined with a first or a first and second immiscible liquid is incubated at hybridization temperature (e.g., 65° C.). After denaturation of the nucleic acid sample, the first aqueous reaction mixture, and optionally, the first or first and second immiscible liquids contacting the first aqueous reaction mixture, can be transferred to the second aqueous reaction mixture to form a third aqueous reaction mixture in contact with first and/or second immiscible liquids. The third aqueous reaction mixture can be a hybrid capture reaction mixture. The hybrid capture reaction mixture can be incubated at a hybridization temperature (e.g., 65° C.) for a suitable period of time (e.g., 10, 20, 30, 45, or 60 minutes, or about 2-4, 4-6, 4-12, 8-24, or 12-48 hrs).

After incubation at the hybridization temperature, functionalized solid surfaces (e.g., beads), wherein the solid surfaces are functionalized with an immobilized affinity reagent that specifically binds the label of the labeled bait oligonucleotides can be combined with the aqueous reaction mixture. In some cases, the composition containing the hybrid capture reaction mixture and one or two immiscible liquids is transferred to a second container containing the functionalized solid surfaces, and optionally one or more immiscible liquids. In some cases, the functionalized solid surfaces (e.g., a suspension of beads in a second aqueous solution), optionally in combination with one or more immiscible liquids can be transferred to the container containing the aqueous reaction mixture. The aqueous reaction mixture and solid surfaces can be further incubated at a suitable capture temperature (e.g., 65° C.) for a suitable period of time (e.g., 45 minutes).

The combining of one or more additional reagents to a composition containing an aqueous reaction mixture and one or more immiscible liquids (e.g., a top-layer and bottom-layer immiscible liquid) can be performed with one or more intervening thermal equilibration steps as described herein. For example, pipette tips used for transferring reagents and/or reaction mixtures can be contacted with a thermal equilibration fluid (e.g., water or an immiscible liquid) at a target temperature prior to contacting the reagents and/or reaction mixtures. As another example, a destination container (e.g., tube or well) can be thermally equilibrated by contacting, and optionally removing, a thermal equilibration fluid (e.g., water or an immiscible liquid) with the destination container. In some cases, thermal equilibration of both dispensing containers (e.g., pipette tips) and destination containers (e.g., tubes or wells) is performed during transfer.

Transfer of reagents, aqueous reaction mixtures, and compositions containing aqueous reaction mixtures and one or more immiscible liquids can be performed with minimal, no, or substantially no (e.g., less than 10%, 5%, or 1%) sample or reagent loss. In one aspect, a method for transfer of a low volume aqueous reaction mixture can include (a) combining in a first container a volume of an aqueous reaction mixture, a volume of a first immiscible liquid, and optionally a volume of a second immiscible liquid to produce a composition containing an aqueous reaction mixture and the first and second immiscible liquids as described herein; (b) incubating the composition as described herein; and (c) transferring substantially all (e.g., at least 90%, 95%, or 99%) of the aqueous reaction mixture of (b) to a second container. In some cases, the method includes performing one or more thermal equilibration steps of the transfer pipette(s) and/or the second container. In some cases, the first container and second container are at the same, or substantially the same (e.g., within about 5%, or 10%) temperature. In some cases, the first container is at a first temperature and the second container is at a second temperature.

In some cases, (c) includes transferring at least 25% of the top- and/or bottom-layer immiscible liquid(s). In some cases, (c) includes transferring at least 50% of the top- and/or bottom-layer immiscible liquid(s). In some cases, (c) includes transferring at least 75% of the top- and/or bottom-layer immiscible liquid(s). In some cases, (c) includes transferring at least 90%, 95%, or 99% of the top- and/or bottom-layer immiscible liquid(s). In some cases, (c) includes transferring from about 50% to about 90% of the top- and/or bottom-layer immiscible liquid(s). In some cases, (c) includes transferring all, or substantially all (e.g., at least 90%, 95%, or 99%), of the top- and/or bottom-layer immiscible liquid(s).

In some cases, the volume of the aqueous reaction mixture transferred is at least about 0.5 μL and not more than 5 μL. In some cases, the volume of the first immiscible liquid transferred is at least two or three times the volume of the aqueous reaction mixture. In some cases, the volume of the second immiscible liquid is at least two or three times the volume of the aqueous reaction mixture.

After transfer, one or more steps of reagent addition can be performed. For example, a hybrid capture reaction in the second container can be washed with the addition of one or more wash buffers. In some cases, the wash buffers are at the same temperature of the capture reaction. In some cases, the wash buffers are at room temperature. In some cases, the hybrid capture reaction is washed with a capture temperature reaction wash buffer, further incubated, and then washed with a room temperature wash buffer. As another example, a polymerase and/or nucleotides can be added to the aqueous reaction mixture in the second container to perform nucleic acid amplification. Alternatively, one or more additional aqueous reaction mixture reagents (e.g., buffers, wash buffers, enzymes, proteins, functionalized solid surfaces, etc.) can be present in the second container prior to transfer of the aqueous reaction mixture to the second container. For example, the aqueous reaction mixture can be a hybrid capture reaction with biotinylated bait oligonucleotides and streptavidin beads can be present in the second container prior to transfer. Transfer of the aqueous reaction mixture can then allow immobilization of target nucleic acids hybridized to the bait oligonucleotides onto the beads.

In some cases, a first reaction is performed in the first container, the aqueous reaction mixture is transferred, and a second reaction is performed in the second container. For example, hybrid capture can be performed in the first container, and target nucleic acid amplification can be performed in the second container. As another example, hybridization of target and bait nucleic acid can be performed in a first container, capture of hybridized targets can be performed in a second container, and amplification of targets can be performed in a third container.

Accordingly, in one aspect, a method of low volume liquid handling can include: (a), transferring any of the compositions containing an aqueous reaction mixture and one or more (e.g., a top-layer and optionally a bottom-layer) immiscible liquid(s) as described herein from a first container to (b), a second container, and then (c), to a third container, wherein substantially all (e.g., at least 90%, 95%, or 99%) of the aqueous reaction mixture is transferred. In some cases, (c) includes transferring at least 25% of the top- and/or bottom-layer immiscible liquid(s). In some cases, (c) includes transferring at least 50% of the top- and/or bottom-layer immiscible liquid(s).). In some cases, (c) includes transferring at least 75% of the top- and/or bottom-layer immiscible liquid(s). In some cases, (c) includes transferring at least 90%, 95%, or 99% of the top- and/or bottom-layer immiscible liquid(s). In some cases, (c) includes transferring from about 50% to about 90% of the top- and/or bottom-layer immiscible liquid(s). In some cases, (c) includes transferring all, or substantially all (e.g., at least 90%, 95%, or 99%), of the top- and/or bottom-layer immiscible liquid(s).

### V. Compositions and Articles of Manufacture

Described herein are compositions and articles of manufacture. In one aspect the composition and article of manufacture can include: a composition containing an aqueous reaction mixture and one or more (e.g., a top-layer and optionally a bottom-layer) immiscible liquid(s) as described herein, wherein the composition is in a tube. For example, the composition can be in a microcentrifuge tube (e.g., a 0.2, 0.5, 1, 1.5, 1.7, or 2 mL microcentrifuge tube) or a PCR tube (e.g., a 0.2 or 0.5 mL PCR tube). In another aspect, the composition and article of manufacture can include: a composition containing an aqueous reaction mixture and one or more (e.g., a top-layer and optionally a bottom-layer) immiscible liquid(s) as described herein, wherein the composition is in a well. For example, the composition can be in a well of a microplate (e.g., a well of a 96-, 384- 1536- or 3456 well microplate). In another aspect, the composition and article of manufacture can include: a composition containing an aqueous reaction mixture and one or more (e.g., a top-layer and optionally a bottom-layer) immiscible liquid(s) as described herein, wherein the composition is in a pipette tip. For example, the composition can be in a P2, P10, P20, P50, P100, P200, or P1000 pipette tip.

### VI. Systems

Described herein is a system for liquid handling of compositions containing a low volume aqueous reaction mixture and a first and/or second immiscible liquid. In one aspect, the system contains i) an array of reaction chambers containing a plurality of individual compositions, the individual compositions containing a low volume aqueous reaction mixture and a first immiscible liquid, wherein the combined volume of the aqueous reaction mixture and first immiscible liquid is at least about 5 μL and no more than about 50 μL; and ii) an array of pipettes (e.g., P10, P50, P100, or P200 pipettes), wherein the system is configured to maintain the plurality of low volume aqueous reaction mixtures at a temperature of about 65° C. for a duration of between about 10 minutes and 1 hour (e.g., 10 minutes, 15 minutes, 30 minutes, 45 minutes, or <1 hr).

In another aspect, the system contains i) an array of reaction chambers containing a plurality of individual compositions, the individual compositions containing a low volume aqueous reaction mixture, a first immiscible liquid, and a second immiscible liquid, wherein the first immiscible liquid is less dense than the aqueous reaction mixture and the second immiscible liquid is more dense than the aqueous reaction mixture; and ii) an array of pipettes (e.g., P10, P50, P100, or P200 pipettes).

### VII. Examples

### Example 1: Aqueous Reaction Mixture with One Immiscible Liquid

25 μL of Qiagen Vapor-Lock® is dispensed into a well of a 96-well microplate. A 2 hybrid capture reaction mixture containing 500 ng of adaptor ligated genomic fragments (from a single, or as many as 96 or more different source gDNA samples), bait oligonucleotides (xGen® Exome Research Panel v1.0 or xGen® Pan-Cancer Panel), blocking oligonucleotides, and blocking DNA (COT-1 DNA®) is added to the well. The well is incubated at 98° C. for 5 minutes, then cooled to 65° C. for an additional 10-30 minutes of incubation. The greater thermal inertia of the aqueous reaction mixture and Qiagen Vapor-Lock® as compared to a composition without the immiscible liquid provides for enhanced thermal control. Moreover, the Qiagen Vapor-Lock® eliminates evaporation of water from the aqueous reaction mixture providing enhanced control of reaction mixture component concentrations.

### Example 2: Aqueous Reaction Mixture with Two Immiscible Liquids

25 μL of Qiagen Vapor-Lock® is dispensed into a well of a 96-well microplate. 10 μL of perfluorooctane is dispensed into the well. A 2 μL hybrid capture reaction mixture containing 500 ng of adaptor ligated genomic fragments (from a single, or as many as 96 or more different source gDNA samples), bait oligonucleotides (xGen® Exome Research Panel v1.0 or xGen® Pan-Cancer Panel), blocking oligonucleotides, and blocking DNA (COT-1 DNA®) is added to the well. The well is incubated at 98° C. for 5 minutes, then cooled to 65° C. for an additional 10-30 minutes of incubation. The greater thermal inertia of the aqueous reaction mixture in combination with the perfluorooctane and Qiagen Vapor-Lock® as compared to a composition without the immiscible liquids provides for enhanced thermal control. Moreover, the Qiagen Vapor-Lock® eliminates evaporation of water from the aqueous reaction mixture providing enhanced control of reaction mixture component concentrations.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope. References and citations to other documents, such as patents, patent applications, patent publications, journals, books, papers, and web contents throughout this disclosure are hereby incorporated herein by reference in their entirety for all purposes.

What is claimed is:

1. A method for low volume liquid handling of an aqueous reaction mixture, the method comprising combining a volume of the aqueous reaction mixture and a volume of a first immiscible liquid and a volume of a second immiscible liquid to produce a composition comprising the aqueous reaction mixture and the first and second immiscible liquids, wherein:
the volume of the aqueous reaction mixture is at least 0.1 μL and not more than 7 μL;
the volume of the first immiscible liquid is at least three times the volume of the aqueous reaction mixture;
the volume of the second immiscible liquid is at least three times the volume of the aqueous reaction mixture; and
one of the first immiscible liquid and the second immiscible liquid is less dense than the aqueous reaction mixture and the other immiscible liquid is more dense than the aqueous reaction mixture.

2. The method of claim 1, wherein the volume of the aqueous reaction mixture is at least 0.5 μL and not more than 5 μL.

3. The method of claim 1, wherein the volume of the first immiscible liquid is at least twice the volume of the second immiscible liquid.

4. The method of any one of the preceding claims, wherein the composition has a total volume that is at least about 15 μL and not more than about 50 μL.

5. The method of claim 1, wherein the combining comprises introducing the aqueous reaction mixture, first immiscible liquid, and second immiscible liquid into a tube or well.

6. The method of claim 5, wherein the tube comprises a microcentrifuge tube having a volumetric capacity of about 0.2 mL.

7. The method of claim 5, wherein the well comprises a well of a microplate having a volumetric capacity of about 0.36 mL.

8. The method of claim 1, wherein the first immiscible liquid is less dense than the aqueous reaction mixture.

9. The method of claim 1, wherein the first immiscible liquid has a boiling point above 100° C.

10. The method of claim 1, wherein the first immiscible liquid is more dense than the aqueous reaction mixture.

11. The method of claim 1, wherein the first immiscible liquid comprises a linear or branched alkyl polymer.

12. The method of claim 1, wherein the second immiscible liquid has a boiling point above 100° C.

13. The method of claim 1, wherein the second immiscible liquid comprises a fluorocarbon polymer.

14. The method of claim 1, wherein the second immiscible liquid is perfluorooctane.

15. The method of claim 1, wherein the volume of the aqueous reaction mixture is about 2 μL, the volume of the first immiscible liquid is about 25 μL, and the volume of the second immiscible liquid is about 10 μL, wherein the first immiscible liquid is less dense than the aqueous reaction mixture and the second immiscible liquid is more dense than the aqueous reaction mixture.

16. The method of any one of the preceding claims, wherein the aqueous reaction mixture comprises nucleic acid.

17. The method of claim 16, wherein the aqueous reaction mixture comprises deoxyribonucleic acid (DNA).

18. The method of claim 16, wherein the aqueous reaction mixture comprises ribonucleic acid (RNA).

19. The method of claim 16, wherein the aqueous reaction mixture comprises DNA and RNA, wherein the DNA comprises adaptor ligated nucleic acid fragments, blocking oligonucleotides, and blocking DNA, and the RNA comprises labeled bait oligonucleotides, wherein the labeled bait oligonucleotides comprise sequences complementary to target fragments of the adaptor ligated nucleic acid fragments.

20. The method of claim 19, wherein the composition comprising the aqueous reaction mixture comprising the DNA and RNA and the first and second immiscible liquids is formed by combining a first composition comprising an RNA aqueous reaction mixture and first and second immiscible liquids and a second composition comprising a DNA aqueous reaction mixture and first and second immiscible liquids.

21. The method of claim 16, wherein the aqueous reaction mixture comprises DNA, wherein the DNA comprises adaptor ligated nucleic acid fragments, blocking oligonucleotides, blocking DNA, and labeled bait oligonucleotides, wherein the labeled bait oligonucleotides comprise sequences complementary to target fragments of the adaptor ligated nucleic acid fragments.

22. The method of claim 19 or 21, wherein the method further comprises combining the aqueous reaction mixture with a plurality of beads, wherein the beads are functionalized with an affinity reagent having affinity to the label of the labeled bait oligonucleotides.

23. The method of claim 19 or 21, wherein the aqueous reaction mixture further comprises a plurality of beads, wherein the beads are functionalized with an affinity reagent having affinity to the label of the labeled bait oligonucleotides.

24. The method of claim 23, wherein the labeled bait oligonucleotides comprise a biotin label and the affinity reagent comprises avidin or streptavidin.

25. The method of any one of the preceding claims, wherein the aqueous reaction mixture is at a temperature of between about 37° C. and about 72° C.

26. The method of claim 16, wherein the aqueous reaction mixture comprises nucleic acid and protein.

27. The method of claim 26, wherein the aqueous reaction mixture comprises DNA and a DNA- or RNA-dependent DNA polymerase.

28. The method of claim 27, wherein the polymerase is heterologous to the DNA.

29. The method of claim 27, wherein the method comprises performing reverse transcription in the aqueous reaction mixture.

30. The method of claim 27, wherein the method comprises performing nucleic acid amplification in the aqueous reaction mixture.

31. The method of any one of claims 1-15, wherein the aqueous reaction mixture comprises an antibody or antibody fragment and a target antigen, wherein the antibody or antibody fragment specifically binds the target antigen.

32. A system for low volume liquid handling of an aqueous reaction mixture, the system comprising:
i) an array of reaction chambers comprising a plurality of individual compositions, the individual compositions containing a low volume aqueous reaction mixture and a first immiscible liquid, wherein the combined volume of the aqueous reaction mixture and first immiscible liquid is at least about 5 μL and no more than about 50 μL; and
ii) an array of pipettes,
wherein the system is configured to maintain the plurality of low volume aqueous reaction mixtures at a temperature of about 65° C. for a duration of between about 10 minutes and 48 hours.

33. The system of claim 32, wherein the system is configured to maintain the plurality of low volume aqueous reaction mixtures at a temperature of about 65° C. for a duration of between about 10 minutes and 1 hour.

34. The system of claim 32, wherein the system is configured to combine the plurality of compositions containing the aqueous reaction mixtures with a plurality of solutions comprising beads functionalized with affinity agents.

35. A system for low volume liquid handling of an aqueous reaction mixture, the system comprising:
i) an array of reaction chambers containing a plurality of individual compositions, the individual compositions containing a low volume aqueous reaction mixture, a first immiscible liquid, and a second immiscible liquid, wherein the first immiscible liquid is less dense than the aqueous reaction mixture and the second immiscible liquid is more dense than the aqueous reaction mixture; and
ii) an array of pipettes.

36. A composition comprising a volume of an aqueous reaction mixture, a volume of a first immiscible liquid, and a volume of a second immiscible liquid, wherein
the volume of the aqueous reaction mixture is at least 0.5 μL and not more than 5 μL;
the first immiscible liquid is less dense than the aqueous reaction mixture and has a volume of at least three times the volume of the aqueous reaction mixture; and
the second immiscible liquid is more dense than the aqueous reaction mixture and has a volume of at least three times the volume of the aqueous reaction mixture.

37. The composition of claim 36, wherein the aqueous reaction mixture comprises nucleic acid.

38. The composition of claim 36, wherein the aqueous reaction mixture comprises deoxyribonucleic acid (DNA).

39. The composition of claim 36, wherein the aqueous reaction mixture comprises ribonucleic acid (RNA).

40. The composition of claim 36, wherein the aqueous reaction mixture comprises nucleic acid and protein.

41. The composition of claim 36, wherein the aqueous reaction mixture comprises DNA and a DNA- or RNA-dependent DNA polymerase.

42. A method of low volume liquid handling comprising:
(a) combining in a first container a volume of an aqueous reaction mixture, a volume of a first immiscible liquid, and a volume of a second immiscible liquid to produce a composition comprising the aqueous reaction mixture and the first and second immiscible liquids, wherein
the volume of the aqueous reaction mixture is at least 0.1 μL and not more than 7 μL;
the volume of the first immiscible liquid is at least three times the volume of the aqueous reaction mixture;
the volume of the second immiscible liquid is at least three times the volume of the aqueous reaction mixture; and
one of the first immiscible liquid and the second immiscible liquid is less dense than the aqueous reaction mixture and the other immiscible liquid is more dense than the aqueous reaction mixture;
(b) incubating the a composition comprising the aqueous reaction mixture and the first and second immiscible liquids for at least 1 minute at a temperature of at least 25° C.; and
(c) transferring substantially all of the composition in (b) to a second container.

43. The method of claim 42, wherein the volume of the aqueous reaction mixture is at least 0.5 μL and not more than 5 μL.

44. The method of claim 42, wherein the aqueous reaction mixture comprises DNA and a DNA- or RNA-dependent DNA polymerase.

45. The method of claim 42, wherein the method further comprises adding additional reagents to the second container.

46. The method of claim 42, wherein the method comprises hybridizing in the aqueous reaction mixture labeled bait oligonucleotides to target nucleic acid fragments in the first container and immobilizing the hybridized target nucleic acid fragments and labeled bait oligonucleotides to beads functionalized with affinity reagents that specifically bind the label of the labeled bait oligonucleotides in the second container.

47. The method of claim 42, wherein the method comprises performing a hybrid capture reaction in the first container to capture target nucleic acid fragments in the aqueous reaction mixture; and amplifying captured target nucleic acid fragments in the second container.

48. The method of claim 42, wherein the temperature of the aqueous reaction mixture is stable to within 10° C. during the transfer.

49. The method of claim 42, wherein the first and second containers are incubated at a same temperature.

50. The method of claim 42, wherein the first container is incubated at a first temperature and the second container is incubated at a second temperature.

51. A method of low volume liquid handling comprising transferring any one of the compositions of claim 36-41 from a first container to a second container, wherein substantially the entire composition is transferred.

52. The method of claim 51, wherein the first container is a tube and the second container is a tube.

53. The method of claim 51, wherein the method further comprises transferring any one of the compositions of claim 36-41 from the second container to a third container, wherein substantially the entire composition is transferred.
